(19) United States
(12) Patent Application Publication
(10) Pub. No.: US 2022/0172147 A1
(43) Pub. Date: Jun. 2, 2022

(54) SYSTEM AND METHOD FOR FACILITATING AN INTERVIEWING PROCESS

(71) Applicant: Talview Inc, San Mateo, CA (US)

(72) Inventor: SANJOE TOM MATHEW JOSE, Clovis, CA (US)

(73) Assignee: Talview Inc

(21) Appl. No.: 17/510,442

(22) Filed: Oct. 26, 2021

Related U.S. Application Data
(60) Provisional application No. 63/118,758, filed on Nov. 27, 2020.

(51) Int. Cl. G06Q 10/06; G06Q 10/10; H04L 12/18

(52) U.S. Cl. CPC G06Q 10/06398; H04L 12/1831; G06Q 10/1053; G06Q 10/06393

(57) ABSTRACT

A system and method for facilitating an interviewing process is disclosed. The method includes extracting audio and video data from one or more interviews and identifying one or more key segments from a plurality of segments. The method further includes determining one or more sentiment parameters by analyzing the extracted video data and determining one or more attributes based on the extracted audio data, the extracted video data, the one or more key segments, the one or more sentiment parameters, job description, resume of the candidate or any combination thereof by using an interview optimization based AI model. The method includes generating a score card based on the determined one or more attributes and predefined criteria by using the interview optimization based AI model and outputting the one or more attributes and the score card on graphical user interface of one or more electronic devices associated with the interviewer.

### EARLIEST PRIORITY DATE

This application claims priority from a Provisional patent application filed in the United States of America having Patent Application No. 63/118,758, filed on Nov. 27, 2020, and titled “SYSTEM AND METHOD FOR EXTRACTING AND USING INTERVIEW INTELLIGENCE TO IMPROVE QUALITY OF INTERVIEWS”.

### FIELD OF INVENTION

Embodiments of the present disclosure relate to a recruitment system and more particularly relates to a system and a method for facilitating an interviewing process.

### BACKGROUND

Interviews are one of the most used methods to evaluate a candidate's eligibility for opportunities for job, promotion, higher studies, and the like. Therefore, thoroughness and fairness of the evaluation process is very important. The ability of an interviewer to interact with a candidate and unearth sufficient information to determine the candidate's eligibility is a crucial step of the evaluation process as the interviewer represents the organization during the interview. Often organizations may end up with poor decisions as there is no formal training process for interviewers, no quality review is performed on their interviewing technique, and no analysis is performed on the success of their decision to approve or reject any candidate in a systematic manner. Moreover, sometimes the interviews become biased due to unconscious biases of the interviewer. Improper training of the interviewer, lack of reviews and poor analysis may lead to poor decisions and being unfair to candidates who are actually deserving.

Hence, there is a need for a system and method for facilitating an interviewing process in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for facilitating an interviewing process is disclosed. The computing system includes one or more hardware processors and a memory coupled to the one or more hardware processors. The memory includes a plurality of modules in the form of programmable instructions executable by the one or more hardware processors. The plurality of modules include a data extraction module configured to extract audio and video data from one or more interviews between an interviewer and a candidate. The plurality of modules also include a key segment identification module configured to identify one or more key segments from a plurality of segments. The plurality of segments are identified from the extracted audio data corresponding to the interviewer and the candidate. The plurality of modules further include a data determination module configured to determine one or more sentiment parameters for the interviewer and the candidate by analyzing the extracted video data. The one or more sentiment parameters include emotion, attitude and thought of the interviewer and the candidate. Also, the data determination module is configured to determine one or more attributes associated with the one or more interviews based on at least one of: the extracted audio data, the extracted video data, the one or more key segments, the one or more sentiment parameters, job description and resume of the candidate by using an interview optimization based Artificial Intelligence (AI) model. Furthermore, the plurality of modules include a score card generation module configured to generate a score card associated with the interviewer including one or more interviewer profile parameters based on the determined one or more attributes and predefined criteria by using the interview optimization-based AI model. Also, the plurality of modules include a data output module configured to output the determined one or more attributes and the generated score card on graphical user interface of one or more electronic devices associated with the interviewer.

In accordance with another embodiment of the present disclosure, a method for facilitating an interviewing process is disclosed. The method includes extracting audio and video data from one or more interviews between an interviewer and a candidate. The method also includes identifying one or more key segments from a plurality of segments. The plurality of segments are identified from the extracted audio data corresponding to the interviewer and the candidate. The method further includes determining one or more sentiment parameters for the interviewer and the candidate by analyzing the extracted video data. The one or more sentiment parameters include emotion, attitude and thought of the interviewer and the candidate. Further, the method includes determining one or more attributes associated with the one or more interviews based on at least one of: the extracted audio data, the extracted video data, the one or more key segments, the one or more sentiment parameters, job description and resume of the candidate by using an interview optimization based Artificial Intelligence (AI) model. Also, the method includes generating a score card associated with the interviewer including one or more interviewer profile parameters based on the determined one or more attributes and predefined criteria by using the interview optimization-based AI model. Furthermore, the method includes outputting the determined one or more attributes and the generated score card on graphical user interface of one or more electronic devices associated with the interviewer.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment capable of facilitating an interviewing process, in accordance with an embodiment of the present disclosure;

FIG. 2 is a block diagram illustrating an exemplary computing system, such as those shown in FIG. 1, capable of facilitating the interviewing process, in accordance with an embodiment of the present disclosure;

FIG. 3 is a process flow diagram illustrating an exemplary method for facilitating the interviewing process, in accordance with an embodiment of the present disclosure;

FIGS. 4A-B is a graphical user interface screen of web application capable of outputting one or more attributes associated with one or more interviews, in accordance with an embodiment of the present disclosure;

FIGS. 4C-D is the graphical user interface screen of the web application capable of outputting score card associated with interviewer, in accordance with an embodiment of the present disclosure; and

FIG. 5 is a schematic representation for facilitating the interviewing process, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Although the explanation is limited to a single interviewer and candidate, it should be understood by the person skilled in the art that the computing system is applied if there are more than one interviewer and candidate.

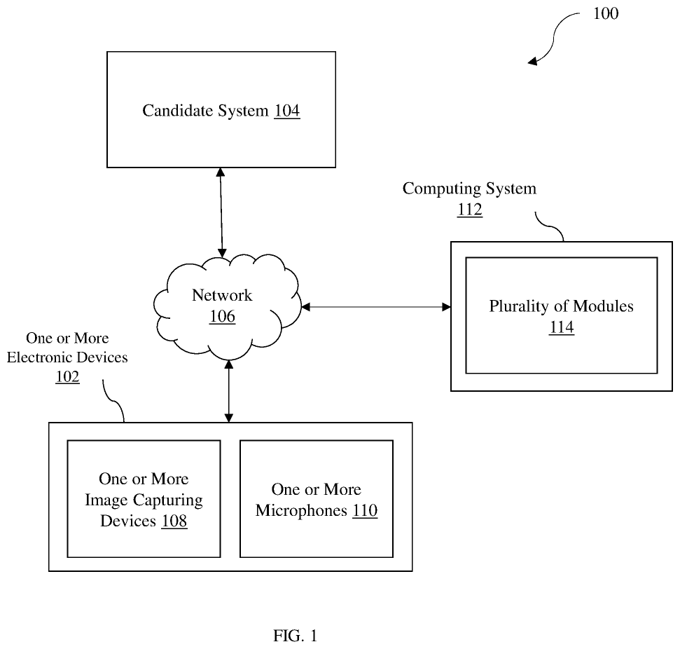

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 capable of facilitating an interviewing process, in accordance with an embodiment of the present disclosure. According to FIG. 1, the computing environment 100 includes one or more electronic devices 102 associated with an interviewer communicatively coupled to a candidate system 104 associated with a candidate via a network 106. In an embodiment of the present disclosure, the interviewer may use the one or more electronic devices 102 and the candidate may use the candidate system 104 for conducting one or more interviews. In an alternative embodiment of the present disclosure, the one or more interviews may also be traditional face to face interviews. The one or more electronic devices 102 and the candidate system 104 may be a laptop computer, desktop computer, tablet computer, smartphone, wearable device, smart watch and the like. In an exemplary embodiment of the present disclosure, the network 106 may be internet.

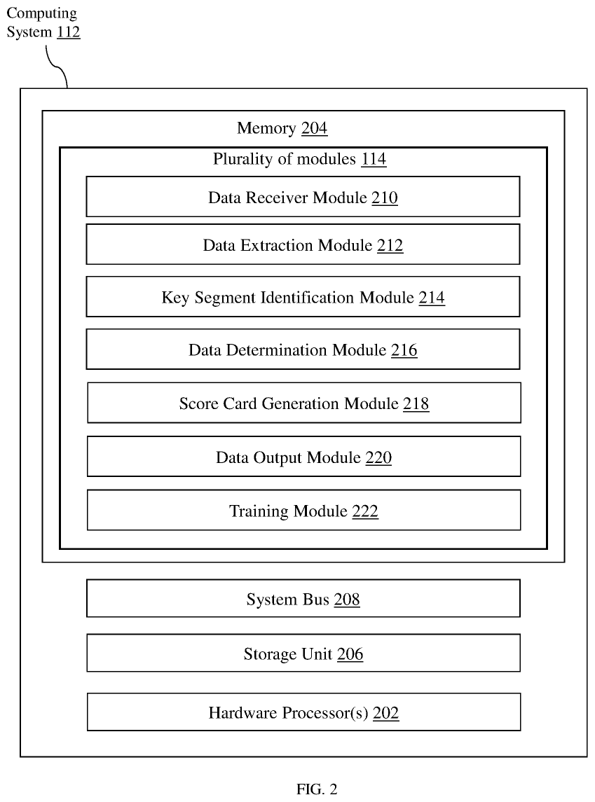

Further, the one or more electronic devices 102 include one or more image capturing devices 108 and one or more microphones 110. The one or more image capturing devices 108 and the one or more microphones 110 capture the one or more interviews between the interviewer and the candidate. In an alternative embodiment of the present disclosure, the one or more image capturing devices and one or more microphones may be placed in a meeting room to capture the traditional face to face interviews. Furthermore, the one or more electronic devices 102 associated with the interviewer are communicatively coupled to a computing system 112 via the network 106. The one or more electronic devices 102 include a web browser and a mobile application to access the computing system 112 via the network 106. In an embodiment of the present disclosure, the customer may use a web application through the web browser to access the computing system 112. The customer may use the computing system 112 to determine one or more attributes and generate a score card for facilitating the interviewing process. The computing system 112 may be a central server, such as cloud server or a remote server. In an embodiment of the present disclosure, the computing system 112 may be seamlessly integrated with video communications platforms or human resources management systems for facilitating the interviewing process. Furthermore, the computing system 112 includes a plurality of modules 114. Details on the plurality of modules 114 have been elaborated in subsequent paragraphs of the present description with reference to FIG. 2.

In an embodiment, the computing system 112 is configured to receive the one or more interviews captured by the one or more image capturing devices 108 and the one or more microphones 110. The computing system 112 extracts audio and video data from the received one or more interviews between the interviewer and the candidate. Further, the computing system 112 also identifies one or more key segments from a plurality of segments. The plurality of segments are identified from the extracted audio data corresponding to the interviewer and the candidate. The computing system 112 determines one or more sentiment parameters for the interviewer and the candidate by analyzing the extracted video data. The one or more sentiment parameters include emotion, attitude, thought of the interviewer and the candidate and the like. Furthermore, the computing system 112 determines one or more attributes associated with the one or more interviews based on the extracted audio data, the extracted video data, the one or more key segments, the one or more sentiment parameters, job description, resume of the candidate or any combination thereof by using an interview optimization based Artificial Intelligence (AI) model. The computing system 112 generates a score card associated with the interviewer including one or more interviewer profile parameters based on the determined one or more attributes and predefined criteria by using the interview optimization-based AI model. The computing system 112 also outputs the determined one or more attributes and the generated score card on graphical user interface of the one or more electronic devices 102 associated with the interviewer.

FIG. 2 is a block diagram illustrating an exemplary computing system 112, such as those shown in FIG. 1, capable of facilitating an interviewing process. The computing system 112 comprises one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 114 in the form of programmable instructions executable by the one or more hardware processors 202. Further, the plurality of modules 114 includes a data receiver module 210, a data extraction module 212, a key segment identification module 214, a data determination module 216, a score card generation module 218, a data output module 220 and a training module 222.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 114 stored in the form of machine-readable instructions on any of the above-mentioned storage media and may be in communication with and executed by the one or more hardware processors 202.

The storage unit 206 may be a cloud storage. The storage unit 206 may store the one or more attributes associated with the one or more interviews and the score card associated with the interviewer. The storage unit 206 may also store the predefined criteria, predefined score associated with each of the one or more attributes and the one or more interviews.

The data receiver module 210 is configured to receive the one or more interviews between the candidate and the interviewer captured by the one or more image capturing devices 108 and the one or more microphones 110. In an embodiment of the present disclosure, the one or more interviews may be ongoing interviews. In another embodiment of the present disclosure, the one or more interviews may be pre-stored interviews stored in the storage unit 206.

The data extraction module 212 is configured to extract audio and video data from the one or more interviews between the interviewer and the candidate.

The key segment identification module 214 is configured to identify one or more key segments from a plurality of segments. The plurality of segments are identified from the extracted audio data corresponding to the interviewer and the candidate. In identifying the one or more key segments from the plurality of segments, the key segment identification module 214 converts the extracted audio data into a plurality of text streams using a natural language processing technique and an audio analytic technique. An Audio stream is further analyzed using acoustic models and techniques such as Voice tremor analysis, to generate speech patterns length, silence, talk ratios, and frequency. Further, the key segment identification module 214 determines one or more portions of the plurality of text streams corresponding to the interviewer and the candidate. In an embodiment of the present disclosure, the key segment identification module 214 may identify one or more conversation dividers between the interviewer and the interviewee to determine the one or more portions of the plurality of text streams corresponding to the interviewer and the candidate. The audio stream is run through dedicated speaker diarization technology, and the audio stream is partitioned in segments to identify the speaker and the number of speakers. The key segment identification module 214 divides the plurality of text streams into the plurality of segments based on the determined one or more portions. Furthermore, the key segment identification module 214 annotates the plurality of segments. The key segment identification module 214 identifies the one or more key segments from the annotated plurality of segments. The one or more key segments are sections of the plurality of segments in which relevant topics are discussed, such as qualification, experience, soft skills of the candidate and the like. In an embodiment of the present disclosure, the key segment identification module 214 may determine and assign identity of the interviewer and the candidate by analyzing the extracted audio data using an audio analytics technique. The key segment identification module 214 stores the unique ID of the interview participants while joining the online meeting/interview. During the speaker diarization process, the key segment identification module 214 identifies the interviewer and the candidate with the relevant details such as email, name, user thumbnail picture and the like.

The data determination module 216 is configured to determine one or more sentiment parameters for the interviewer and the candidate by analyzing the extracted video data. In an exemplary embodiment of the present disclosure, the one or more sentiment parameters include emotion, attitude, thought of the interviewer and the candidate and the like. In determining the one or more sentiment parameters for the interviewer and the candidate by analyzing the extracted video data, the data determination module 216 determines identity of the interviewer and the candidate by analyzing the extracted video data using a video analytics technique. For example, the actors/characters are assigned to the platform information with unique IDs, email, name, and user thumbnail pictures and the like. The video analytics analyzes the inactivity in a conversation and identify any objects from the interview environment. Body language and communication effectiveness is analyzed. Further, the data determination module 216 determines the one or more sentiment parameters corresponding to the determined identity of the interviewer and the candidate by performing sentiment analysis on the extracted video data.

Further, the data determination module 216 determines one or more attributes associated with the one or more interviews based on the extracted audio data, the extracted video data, the one or more key segments, the annotated plurality of segments, the one or more sentiment parameters, job description, resume of the candidate or any combination thereof by using an interview optimization based Artificial Intelligence (AI) model. In an exemplary embodiment of the present disclosure, the one or more attributes include talk ratio, inactivity, sentiment level, plurality of keywords, STAR Range, candidate at risk, questions asked by the interviewer during the one or more interviews, interview biased probability, relevance of the one or more interviews to the job description, company pitch, assessment report reference and the resume of the candidate and the like. In case of candidate at risk, if a candidate was spoken between the below-mentioned ratios, the candidate risk metric changes accordingly. For example, 10-35% or >80%—High (Red), 36-44% or 56% to 80% Medium (Amber) and 45-55%—Low (Green). The Ideal range may be between 45 to 55%.

Talk ratio is ratio of time spent by the interviewer and the candidate in the one or more interviews. Inactivity is a time-period associated with the one or more interviews in which the interviewer and the candidate are in ideal state. In an embodiment of the present disclosure, the determined identity of the interviewer and the candidate may also be used to determine the one or more attributes, such as the talk ratio and the inactivity. The STAR range includes situation, task, action and result. In an embodiment of the present disclosure, each of the one or more attributes may have a predefined score associated with it. In obtaining relevance of the one or more interviews to the job description, the company pitch, the assessment report reference and the resume of the candidate, the data determination module 216 extracts the plurality of keywords from the job description, the company pitch, the assessment report reference and the resume of the candidate. Further, the data determination module 216 maps the extracted plurality of keywords with the plurality of segments. The data determination module 216 determines relevance of the one or more interviews to the job description, the company pitch, the assessment report reference and the resume of the candidate based on the result of mapping. For example, when most of the extracted plurality of keywords are covered in the plurality of segments, it may be said that the one or more interviews are relevant to the job description, the company pitch, the assessment report reference and the resume of the candidate. In an embodiment of the present disclosure, the data determination module 216 may also identify where each of the extracted plurality of keywords is used in the one or more interviews.

The score card generation module 218 is configured to generate a score card associated with the interviewer including one or more interviewer profile parameters based on the determined one or more attributes and predefined criteria by using the interview optimization-based AI model. In an exemplary embodiment of the present disclosure, the one or more profile parameters include interview evaluations, number of interviews completed, learning score, number of comments, average candidate rating, time to interview, offer acceptance rate, select or reject ratio, average repeated questions per interview, compliance with guidance, interviewer learning path recommendation and the like. The interview evaluations may be number of interview evaluations completed by an interviewer, the leaning score may be the interview learning score for an Interviewer (computed based on the completion of learning path assessments). The number of comments includes comments that was received for an interviewer from past candidates during interviewer feedback. The average candidate rating may be computed based on each candidate's interviewer feedback rating. The compliance with guidance is when an interviewer will have Interview guidelines check-list, the score card generation module 218 analyzes whether Interview is meeting with Interview Guidelines. The interviewer learning path recommendation refers to path or stage when every Interviewer goes through an assessment, to assess an interviewer in certain areas such as DEI readiness, Domain Knowledge, Interviewing Techniques, Candidate Experience, and the like. The offer acceptance rate is rate at which job offer is accepted by the candidates. Further, the select or reject ratio is a ratio at which the interviewer selects the candidates. In an embodiment of the present disclosure, the predefined criteria may be used to obtain the compliance with guidance. In generating the score card associated with the interviewer including the one or more interviewer profile parameters based on the determined one or more attributes and the predefined criteria by using the interview optimization-based AI model, the score card generation module 218 generates one or more scores corresponding to each of the one or more attributes based on the determined one or more attributes and the predefined criteria by using the interview optimization-based AI model. Further, the score card generation module 218 generates the score card for the generated one or more scores by using the interview optimization-based AI model.

The data output module 220 is configured to output the determined one or more attributes and the generated score card on graphical user interface of the one or more electronic devices 102 associated with the interviewer. In an embodiment of the present disclosure, the interviewer may use the outputted one or more attributes and the score card for training himself/herself. Further, the data output module 220 outputs one or more notifications corresponding to the extracted plurality of keywords on the graphical user interface of the one or more electronic devices 102 based on the mapping of the extracted plurality of keywords with the plurality of segments. In an embodiment of the present disclosure, the data output module 220 outputs the one or more notifications corresponding to the extracted plurality of keywords for ascertaining that all the extracted plurality of keywords are covered by the interviewer during the one or more interviews. For example, when the interviewer forgets to cover keywords related to the job description, the data outputting module outputs the one or more notifications corresponding to the keywords related to the job description. The one or more notifications may be in the form of visual, audio, audio visual and the like. In an exemplary embodiment of the present disclosure, the one or more notifications include one or more images with the plurality of keywords, one or more cues with the plurality of keywords and the like. In an embodiment of the present disclosure, the one or more notifications may be outputted in real-time.

The training module 222 is configured to provide offer acceptance and job performance of the candidate selected by the interviewer as inputs to the interview optimization-based AI model for training. In an embodiment of the present disclosure, when the interview optimization-based AI model is trained based on the offer acceptance and job performance of the candidate selected by the interviewer, the interview optimization-based AI model may determine success rate of the interviewer in selecting the candidate. For example, when the job performance of the candidate selected by the interviewer is good, the success rate of the interviewer is high. Further, when the job performance of the candidate selected by the interviewer is poor, the success rate of the interviewer is low.

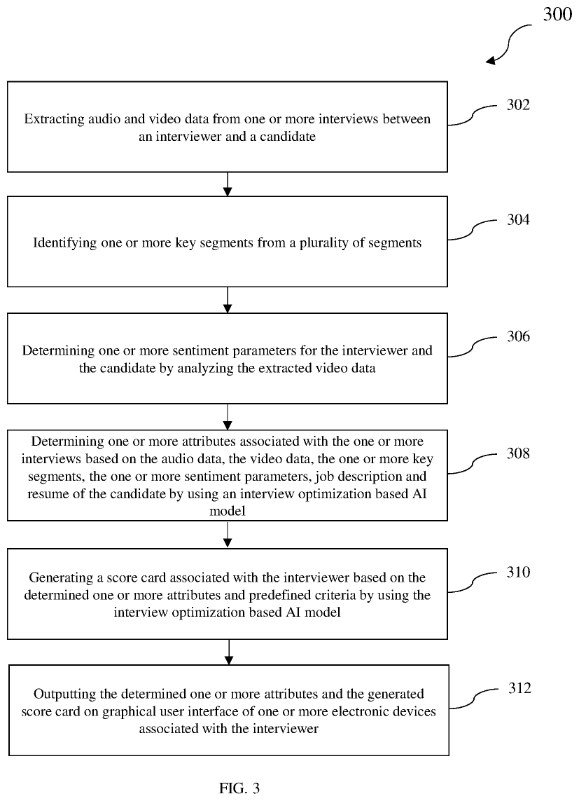

FIG. 3 is a process flow diagram illustrating an exemplary method 300 for facilitating an interviewing process, in accordance with an embodiment of the present disclosure. At step 302, audio and video data is extracted from one or more interviews between an interviewer and a candidate. In an embodiment of the present disclosure, the one or more interviews may be captured by the one or more image capturing devices 108 and the one or more microphones 110. In an embodiment of the present disclosure, the one or more interviews may be ongoing interviews. In another embodiment of the present disclosure, the one or more interviews may be pre-stored interviews stored in a storage unit 206.

At step 304, one or more key segments is identified from a plurality of segments. The plurality of segments are identified from the extracted audio data corresponding to the interviewer and the candidate. In identifying the one or more key segments from the plurality of segments, the method 300 includes converting the extracted audio data into a plurality of text streams using a natural language processing technique and an audio analytic technique. Further, the method 300 includes determining one or more portions of the plurality of text streams corresponding to the interviewer and the candidate. In an embodiment of the present disclosure, the one or more conversation dividers between the interviewer and the interviewee may be identified to determine the one or more portions of the plurality of text streams corresponding to the interviewer and the candidate. The method 300 includes dividing the plurality of text streams into the plurality of segments based on the determined one or more portions. Furthermore, the method 300 includes annotating the plurality of segments. The method 300 includes identifying the one or more key segments from the annotated plurality of segments. The one or more key segments are sections of the plurality of segments in which relevant topics are discussed, such as qualification, experience, soft skills of the candidate and the like. In an embodiment of the present disclosure, the method 300 includes determining and assigning identity of the interviewer and the candidate by analyzing the extracted audio data using an audio analytics technique.

At step 306, one or more sentiment parameters for the interviewer and the candidate are determined by analyzing the extracted video data. In an exemplary embodiment of the present disclosure, the one or more sentiment parameters include emotion, attitude, thought of the interviewer and the candidate and the like. In determining the one or more sentiment parameters for the interviewer and the candidate by analyzing the extracted video data, the method 300 includes determining identity of the interviewer and the candidate by analyzing the extracted video data using a video analytics technique. Further, the method 300 includes determining the one or more sentiment parameters corresponding to the determined identity of the interviewer and the candidate by performing sentiment analysis on the extracted video data.

At step 308, one or more attributes associated with the one or more interviews are determined based on the extracted audio data, the extracted video data, the one or more key segments, the annotated plurality of segments, the one or more sentiment parameters, job description, resume of the candidate or any combination thereof by using an interview optimization based Artificial Intelligence (AI) model. In an exemplary embodiment of the present disclosure, the one or more attributes include talk ratio, inactivity, sentiment level, plurality of keywords, STAR Range, candidate at risk, questions asked by the interviewer during the one or more interviews, interview biased probability, relevance of the one or more interviews to the job description, company pitch, assessment report reference and the resume of the candidate and the like. Talk ratio is ratio of time spent by the interviewer and the candidate in the one or more interviews. Inactivity is a time-period associated with the one or more interviews in which the interviewer and the candidate are in ideal state. In an embodiment of the present disclosure, the determined identity of the interviewer and the candidate may also be used to determine the one or more attributes, such as the talk ratio and the inactivity. The STAR range includes situation, task, action and result. In an embodiment of the present disclosure, each of the one or more attributes may have a predefined score associated with it. In obtaining relevance of the one or more interviews to the job description, the company pitch, the assessment report reference and the resume of the candidate, the method 300 includes extracting the plurality of keywords from the job description, the company pitch, the assessment report reference and the resume of the candidate. Further, the method 300 includes mapping the extracted plurality of keywords with the plurality of segments. The method 300 includes determining relevance of the one or more interviews to the job description, the company pitch, the assessment report reference and the resume of the candidate based on the result of mapping. For example, when most of the extracted plurality of keywords are covered in the plurality of segments, it may be said that the one or more interviews are relevant to the job description, the company pitch, the assessment report reference and the resume of the candidate. In an embodiment of the present disclosure, it may be identified where each of the extracted plurality of keywords is used in the one or more interviews.

At step 310, a score card associated with the interviewer including one or more interviewer profile parameters is generated based on the determined one or more attributes and predefined criteria by using the interview optimization-based AI mode. In an exemplary embodiment of the present disclosure, the one or more profile parameters include interview evaluations, number of interviews completed, learning score, number of comments, average candidate rating, time to interview, offer acceptance rate, select or reject ratio, average repeated questions per interview, compliance with guidance, interviewer learning path recommendation and the like. The offer acceptance rate is rate at which job offer is accepted by the candidates. Further, the select or reject ratio is a ratio at which the interviewer selects the candidates. In an embodiment of the present disclosure, the predefined criteria may be used to obtain the compliance with guidance. In generating the score card associated with the interviewer including the one or more interviewer profile parameters based on the determined one or more attributes and the predefined criteria by using the interview optimization-based AI model, the method 300 includes generating one or more scores corresponding to each of the one or more attributes based on the determined one or more attributes and the predefined criteria by using the interview optimization-based AI model. Further, the method 300 includes generating the score card for the generated one or more scores by using the interview optimization-based AI model.

At step 312, the determined one or more attributes and the generated score card are outputted on graphical user interface of one or more electronic devices 102 associated with the interviewer. The one or more electronic devices 102 may include a laptop computer, desktop computer, tablet computer, smartphone, wearable device, smart watch and the like. In an embodiment of the present disclosure, the interviewer may use the outputted one or more attributes and the score card for training himself/herself. Further, the method 300 includes outputting one or more notifications corresponding to the extracted plurality of keywords on the graphical user interface of the one or more electronic devices 102 based on the mapping of the extracted plurality of keywords with the plurality of segments. In an embodiment of the present disclosure, the method 300 includes outputting the one or more notifications corresponding to the extracted plurality of keywords for ascertaining that all the extracted plurality of keywords are covered by the interviewer during the one or more interviews. For example, when the interviewer forgets to cover keywords related to the job description, the one or more notifications may be outputted corresponding to the keywords related to the job description. The one or more notifications may be in the form of visual, audio, audio visual and the like. In an exemplary embodiment of the present disclosure, the one or more notifications include one or more images with the plurality of keywords, one or more cues with the plurality of keywords and the like. In an embodiment of the present disclosure, the one or more notifications may be outputted in real-time.

In an embodiment of the present disclosure, the method 300 also includes providing offer acceptance and job performance of the candidate selected by the interviewer as inputs to the interview optimization based AI model for training. In an embodiment of the present disclosure, when the interview optimization-based AI model is trained based on the offer acceptance and job performance of the candidate selected by the interviewer, the interview optimization-based AI model may determine success rate of the interviewer in selecting the candidate. For example, when the job performance of the candidate selected by the interviewer is good, the success rate of the interviewer is high. Further, when the job performance of the candidate selected by the interviewer is poor, the success rate of the interviewer is low.

The method 300 may be implemented in any suitable hardware, software, firmware, or combination thereof.

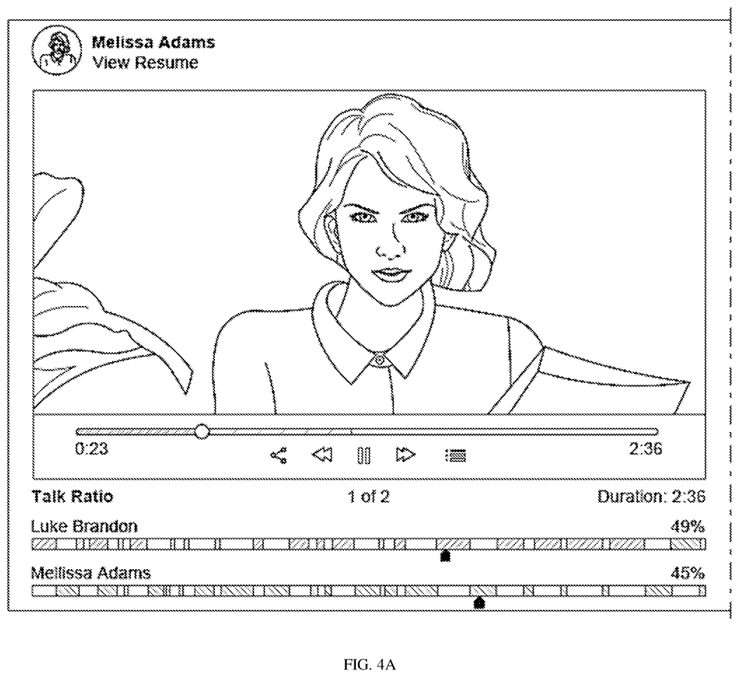

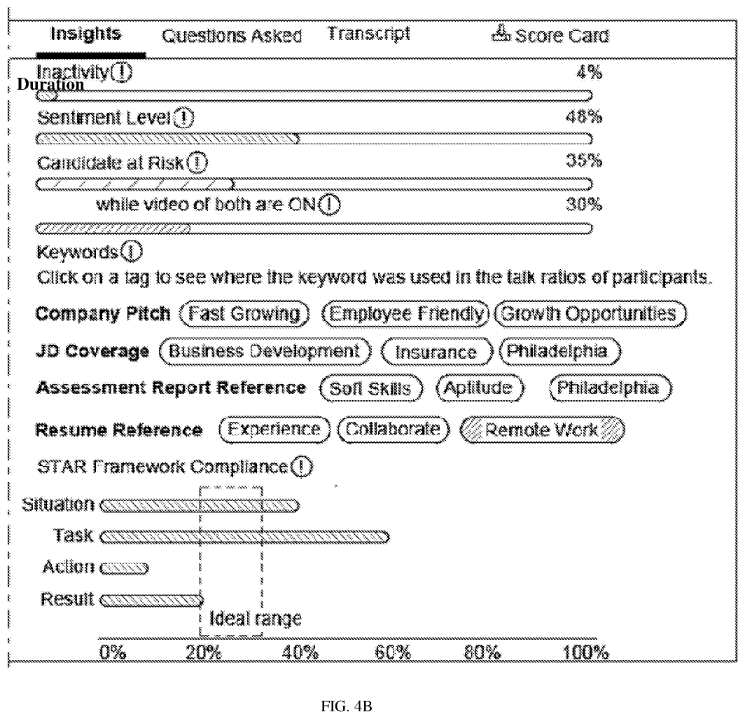

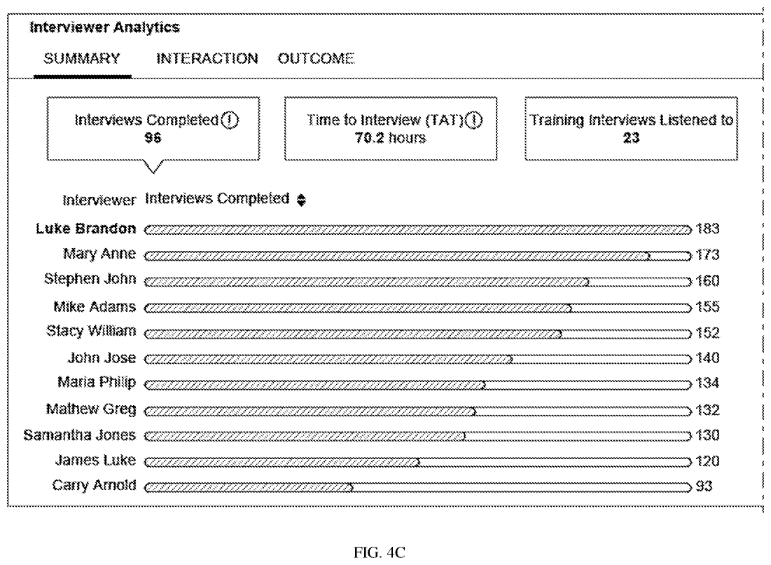

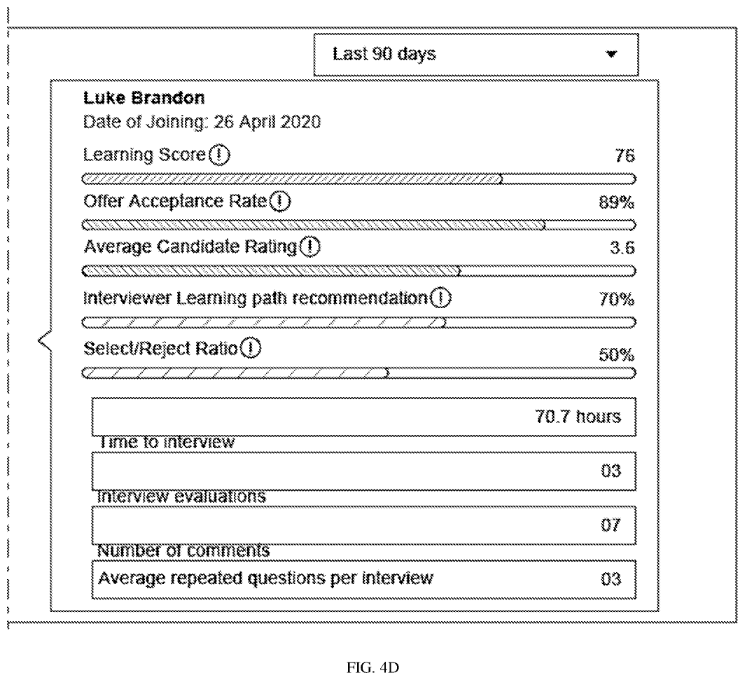

FIG. 4A-D is a graphical user interface screen of the web application capable of outputting the one or more attributes and the score card for facilitating the interviewing process, in accordance with an embodiment of the present disclosure. The graphical user interface screen of the web application may be accessed by the interviewer via the one or more electronic devices 102. FIG. 4A-B is the graphical user interface screen of the web application capable of outputting the one or more attributes associated with the one or more interviews, which is earlier explained with respect to FIG. 2. The graphical user interface screen displays the one or more interviews, duration of the one or more interviews, talk ratio, the plurality of segments corresponding to the interviewer i.e., Luke Brandon and the candidate i.e., Melissa Adams, as shown in FIG. 4A. In the current scenario, the talk ratio for the interviewer is 49% and the talk ratio for the candidate is 45%. Further, the graphical user interface screen displays insights including inactivity, sentiment level, candidate at risk, duration while video of both are ON and star framework compliance along with their respective scores, questions asked by the interviewer during the one or more interviews and transcript as shown in FIG. 4B. In an embodiment of the present disclosure, the STAR framework compliance is displayed along with its ideal range. Furthermore, the interviewer may also click on the plurality of keywords corresponding to the company pitch, job description, assessment report reference and resume of the candidate to identify where each of the extracted plurality of keywords is used in the one or more interviews.

FIG. 4C-D is the graphical user interface screen of the web application capable of outputting the score card associated with the interviewer, which is earlier explained with respect to FIG. 2. The graphical user interface screen displays summary including interviews completed, time to interview and training interviews listened to, interaction and outcome, as shown in FIG. 4C. Further, the graphical user interface screen also displays date of joining of the interviewer, learning score, offer acceptance rate, average candidate rating, interviewer learning path recommendation, select or reject ratio, time to interview, interview evaluations, number of comments and average repeated questions per interview, as shown in FIG. 4D.

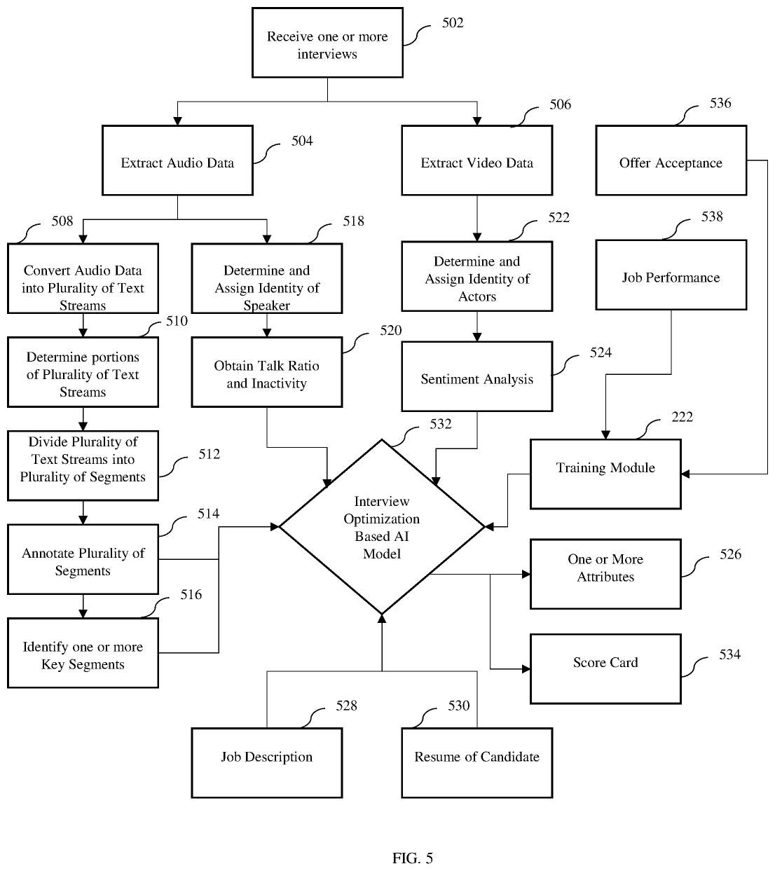

FIG. 5 is a schematic representation for facilitating the interviewing process, in accordance with an embodiment of the present disclosure. The computing system 112 receives one or more interviews 502 captured by the one or more image capturing devices and the one or microphones. Further, the computing system 112 extracts audio data 504 and the video data 506. The computing system 112 coverts the audio data into the plurality of text streams 508. The computing system 112 also determines one or more portions of the plurality of text streams 510 corresponding to the interviewer and the candidate. Furthermore, the computing system 112 divides the plurality of text streams into the plurality of segments 512 based on the determined one or more portions. The computing system 112 annotates the plurality of segments 514. Further, the computing system 112 identifies the one or more key segments 516 from the annotated plurality of segments.

Further, the computing system 112 determines and assigns identity of the interviewer and the candidate 518 by analyzing the extracted audio data using the audio analytics technique. The computing system 112 obtains talk ratio and inactivity 520 based on the determined and assigned identity of the interviewer and the candidate. Furthermore, the computing system 112 determines and assigns identity of the interviewer and the candidate 522 by analyzing the extracted video data using the video analytics technique. The computing system 112 determines the one or more sentiment parameters corresponding to the determined identity of the interviewer and the candidate by performing sentiment analysis 524 on the extracted video data. Further, the computing system 112 determines the one or more attributes 526 associated with the one or more interviews based on the extracted audio data, the extracted video data, the one or more key segments, the annotated plurality of segments, the one or more sentiment parameters, job description 528, resume of the candidate 530 or any combination thereof by using the interview optimization-based AI model 532. The job description 528, and resume of the candidate 530 are ML models, these two models, trained with millions of resumes and job descriptions. The computing system 112 populates relevant keywords and skills, from a resume, the computing system 112 will match and the skills and responsibilities that are mentioned in the job Description from the Resume are retrieved. The computing system 112 also generates the score card 534 associated with the interviewer including the one or more interviewer profile parameters based on the determined one or more attributes and the predefined criteria by using the interview optimization-based AI model 532. The training module 222 is configured to provide offer acceptance 536 and job performance 538 of the candidate selected by the interviewer as inputs to the interview optimization-based AI model 532 for training. The interview optimization-based AI model 532 determines success rate of the interviewer in selecting the candidate.

Thus, various embodiments of the present computing system 112 provide a solution to facilitate interviewing process. Since, the computing system 112 outputs the one or more attributes and the score card on graphical user interface of the one or more electronic devices 102, the interviewer may monitor his/her performance in the one or more interviews based on the one or more attributes and the score card. Further, the interviewer may also improve quality of the one or more interviews to hire the best candidate for his/her organization. The computing system 112 also facilitates in conducting an unbiased and structured interview. Furthermore, the computing system 112 outputs the one or more notifications corresponding to the extracted plurality of keywords on the graphical user interface of the one or more electronic devices 102 for ascertaining that all the extracted plurality of keywords are covered by the interviewer during the one or more interviews.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for facilitating an interviewing process, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a data extraction module configured to extract audio and video data from one or more interviews between an interviewer and a candidate;
a key segment identification module configured to identify one or more key segments from a plurality of segments, wherein the plurality of segments are identified from the extracted audio data corresponding to the interviewer and the candidate;
a data determination module configured to:
determine one or more sentiment parameters for the interviewer and the candidate by analyzing the extracted video data, wherein the one or more sentiment parameters comprise: emotion, attitude and thought of the interviewer and the candidate; and
determine one or more attributes associated with the one or more interviews based on at least one of: the extracted audio data, the extracted video data, the one or more key segments, the one or more sentiment parameters, job description and resume of the candidate by using an interview optimization based Artificial Intelligence (AI) model;
a score card generation module configured to generate a score card associated with the interviewer comprising one or more interviewer profile parameters based on the determined one or more attributes and predefined criteria by using the interview optimization-based AI model; and
a data output module configured to output the determined one or more attributes and the generated score card on graphical user interface of one or more electronic devices associated with the interviewer.

2. The computing system of claim 1, wherein in identifying the one or more key segments from the plurality of segments, the key segment identification module is configured to:
convert the extracted audio data into a plurality of text streams using a natural language processing technique and an audio analytic technique;
determine one or more portions of the plurality of text streams corresponding to the interviewer and the candidate;
divide the plurality of text streams into the plurality of segments based on the determined one or more portions;
annotate the plurality of segments; and
identify the one or more key segments from the annotated plurality of segments.

3. The computing system of claim 1, wherein in determining the one or more sentiment parameters for the interviewer and the candidate by analyzing the extracted video data, the data determination module is configured to:
determine identity of the interviewer and the candidate by analyzing the extracted video data using a video analytics technique; and
determine the one or more sentiment parameters corresponding to the determined identity of the interviewer and the candidate by performing sentiment analysis on the extracted video data.

4. The computing system of claim 1, wherein the one or more attributes is comprised of at least one of a set comprising: talk ratio, inactivity, sentiment level, STAR Range, candidate at risk, choice of words, plurality of keywords, questions asked by the interviewer during the one or more interviews, interview biased probability and relevance of the one or more interviews to the job description, company pitch assessment report reference, and the resume of the candidate, and wherein the one or more profile parameters is comprised of at least one of a set comprising:
interview evaluations, number of interviews completed, score of the one or more attributes, learning score, number of comments, average candidate rating, time to interview, offer acceptance rate, select or reject ratio, average repeated questions per interview, compliance with guidance, and interviewer learning path recommendation.

5. The computing system of claim 4, wherein in obtaining relevance of the one or more interviews to the job description, the company pitch, the assessment report reference and the resume of the candidate, the data determination module is configured to:
extract a plurality of keywords from the job description, the company pitch, the assessment report reference and the resume of the candidate;
map the extracted plurality of keywords with the plurality of segments; and
determine relevance of the one or more interviews to the job description, the company pitch, the assessment report reference and the resume of the candidate based on the result of mapping.

6. The computing system of claim 5, wherein the data output module is configured to output one or more notifications corresponding to the extracted plurality of keywords on the graphical user interface of the one or more electronic devices associated with the interviewer based on the mapping of the extracted plurality of keywords with the plurality of segments.

7. The computing system of claim 1, further comprises a training module configured to provide offer acceptance and job performance of the candidate selected by the interviewer as inputs to the interview optimization-based AI model for training.

8. The computing system of claim 1, wherein in generating the score card associated with the interviewer comprising the one or more interviewer profile parameters based on the determined one or more attributes and the predefined criteria by using the interview optimization-based AI model, the score card generation module is configured to:
generate one or more scores corresponding to each of the one or more attributes based on the determined one or more attributes and the predefined criteria by using the interview optimization-based AI model; and
generate the score card for the generated one or more scores by using the interview optimization-based AI model.

9. A method for facilitating an interviewing process, the method comprising:
extracting, by one or more hardware processors, audio and video data from one or more interviews between an interviewer and a candidate;
identifying, by the one or more hardware processors, one or more key segments from a plurality of segments, wherein the plurality of segments are identified from the extracted audio data corresponding to the interviewer and the candidate;
determining, by the one or more hardware processors, one or more sentiment parameters for the interviewer and the candidate by analyzing the extracted video data, wherein the one or more sentiment parameters comprise: emotion, attitude and thought of the interviewer and the candidate;
determining, by the one or more hardware processors, one or more attributes associated with the one or more interviews based on at least one of: the extracted audio data, the extracted video data, the one or more key segments, the one or more sentiment parameters, job description and resume of the candidate by using an interview optimization based Artificial Intelligence (AI) model;
generating, by the one or more hardware processors, a score card associated with the interviewer comprising one or more interviewer profile parameters based on the determined one or more attributes and predefined criteria by using the interview optimization-based AI model; and
outputting, by the one or more hardware processors, the determined one or more attributes and the generated score card on graphical user interface of one or more electronic devices associated with the interviewer.

10. The method of claim 9, wherein in identifying one or more key segments from the plurality of segments, the method comprises:
converting the extracted audio data into a plurality of text streams using a natural language processing technique and an audio analytic technique;
determining one or more portions of the plurality of text streams corresponding to the interviewer and the candidate;
dividing the plurality of text streams into the plurality of segments based on the determined one or more portions;
annotating the plurality of segments; and
identifying the one or more key segments from the annotated plurality of segments.

11. The method of claim 9, wherein in determining the one or more sentiment parameters for the interviewer and the candidate by analyzing the extracted video data, the method comprises:
determining identity of the interviewer and the candidate by analyzing the extracted video data using a video analytics technique; and
determining the one or more sentiment parameters corresponding to the determined identity of the interviewer and the candidate by performing sentiment analysis on the extracted video data.

12. The method of claim 9, wherein the one or more attributes is comprised of at least one of a set comprising: talk ratio, inactivity, sentiment level, STAR Range, candidate at risk, questions asked by the interviewer during the one or more interviews, interview biased probability, plurality of keywords, choice of words and relevance of the one or more interviews to the job description, company pitch, assessment report reference, and the resume of the candidate, and wherein the one or more profile parameters is comprised of at least one of a set comprising:
interview evaluations, number of interviews completed, score of the one or more attributes, learning score, number of comments, average candidate rating, time to interview, offer acceptance rate, select or reject ratio, average repeated questions per interview, compliance with guidance, and interviewer learning path recommendation.

13. The method of claim 12, wherein in obtaining relevance of the one or more interviews to the job description, the company pitch, the assessment report reference and the resume of the candidate, the method comprises:
extracting a plurality of keywords from the job description, the company pitch, the assessment report reference and the resume of the candidate;
mapping the extracted plurality of keywords with the plurality of segments; and
determining relevance of the one or more interviews to the job description, the company pitch, the assessment report reference and the resume of the candidate based on the result of mapping.

14. The method of claim 13, further comprises outputting one or more notifications corresponding to the extracted plurality of keywords on the graphical user interface of the one or more electronic devices associated with the interviewer based on the mapping of the extracted plurality of keywords with the plurality of segments.

15. The method of claim 9, further comprises providing offer acceptance and job performance of the candidate selected by the interviewer as inputs to the interview optimization-based AI model for training.

16. The method of claim 9, wherein in generating the score card associated with the interviewer comprising the one or more interviewer profile parameters based on the determined one or more attributes and the predefined criteria by using the interview optimization-based AI model, the method comprises:
generating one or more scores corresponding to each of the one or more attributes based on the determined one or more attributes and the predefined criteria by using the interview optimization-based AI model; and
generating the score card for the generated one or more scores by using the interview optimization-based AI model.

17. A non-transitory computer-readable storage medium having instructions stored therein that, when executed by a hardware processor, cause the processor to perform the method steps comprising:
extracting, by one or more hardware processors, audio and video data from one or more interviews between an interviewer and a candidate;
identifying, by the one or more hardware processors, one or more key segments from a plurality of segments, wherein the plurality of segments are identified from the extracted audio data corresponding to the interviewer and the candidate;
determining, by the one or more hardware processors, one or more sentiment parameters for the interviewer and the candidate by analyzing the extracted video data, wherein the one or more sentiment parameters comprise: emotion, attitude and thought of the interviewer and the candidate;
determining, by the one or more hardware processors, one or more attributes associated with the one or more interviews based on at least one of: the extracted audio data, the extracted video data, the one or more key segments, the one or more sentiment parameters, job description and resume of the candidate by using an interview optimization based Artificial Intelligence (AI) model;
generating, by the one or more hardware processors, a score card associated with the interviewer comprising one or more interviewer profile parameters based on the determined one or more attributes and predefined criteria by using the interview optimization-based AI model; and
outputting, by the one or more hardware processors, the determined one or more attributes and the generated score card on graphical user interface of one or more electronic devices associated with the interviewer.

18. The non-transitory computer-readable storage medium of claim 17, further comprises providing offer acceptance and job performance of the candidate selected by the interviewer as inputs to the interview optimization-based AI model for training.

19. The non-transitory computer-readable storage medium of claim 17, further comprises outputting one or more notifications corresponding to the extracted plurality of keywords on the graphical user interface of the one or more electronic devices associated with the interviewer based on the mapping of the extracted plurality of keywords with the plurality of segments.

20. The non-transitory computer-readable storage medium of claim 17, wherein the one or more attributes is comprised of at least one of a set comprising: talk ratio, inactivity, sentiment level, STAR Range, candidate at risk, questions asked by the interviewer during the one or more interviews, interview biased probability, plurality of keywords, choice of words and relevance of the one or more interviews to the job description, company pitch, assessment report reference, and the resume of the candidate, and
wherein the one or more profile parameters is comprised of at least one of a set comprising: interview evaluations, number of interviews completed, score of the one or more attributes, learning score, number of comments, average candidate rating, time to interview, offer acceptance rate, select or reject ratio, average repeated questions per interview, compliance with guidance, and interviewer learning path recommendation.
